(19) United States
(12) Patent Application Publication
(10) Pub. No.: US 2021/0230940 A1
(43) Pub. Date: Jul. 29, 2021

(54) WINDOW COVERING AND MOUNTING ASSEMBLY THEREFOR

(71) Applicant: Hall Labs LLC, Provo, UT (US)

(72) Inventors: David R. Hall, Provo, UT (US); Austin Carlson, Mapleton, UT (US); Casey Webb, Spanish Fork, UT (US); Corey Webb, Spanish Fork, UT (US); Jerome Miles, Spanish Fork, UT (US)

(73) Assignee: Hall Labs LLC, Provo, UT (US)

(21) Appl. No.: 16/752,071

(22) Filed: Jan. 24, 2020

(51) Int. Cl. E06B 9/323; E06B 9/266

(52) U.S. Cl. CPC E06B 9/323; E06B 9/266

(57) ABSTRACT

A window covering is disclosed including a headrail spanning a window casing, and an end cap assembly in an end of the headrail. The end cap assembly includes a carriage, a movable portion extensible from a retracted position in the carriage to an extended position protruding at least partially from the carriage, and a mounting bracket coupled to the movable portion and being configured to forcibly contact the window casing and secure the headrail in the window casing. The assembly also includes a cam contacting the movable portion and being configured to move the movable portion from the retracted position to the extended position. The assembly further includes a flange extending from the cam and contacting the movable portion, the flange being configured to maintain the movable portion in position relative to the carriage. The assembly also includes a lever coupled to the cam. Rotation of the lever causes the cam to move the movable portion.

### TECHNICAL FIELD

The present disclosure is directed to apparatuses, systems, and methods for securing a window covering in a window.

### BACKGROUND

This invention relates to systems and methods for installing window coverings such as blinds, shades, etc. Shades and other similar window coverings are typically installed in windows using mounting brackets that are screwed into the upper corners of window casings. Although effective, this installation technique may require a user to make measurements to ensure that the brackets are installed in the correct locations, as well as require tools (e.g., drills, screwdrivers, etc.) to drive the screws into the window casing. Unfortunately, this installation technique may also leave unsightly holes in the window casing and potentially damage the paint or finish. This installation technique can also be quite time consuming. In a home or building containing many windows to be outfitted with shades or other window coverings, the installation time may increase accordingly.

In order to reduce the amount of time and effort needed to install window coverings, installation techniques have been developed. One such technique involves placing spring-loaded mounting brackets at the end of a window covering headrail. When the window covering headrail is placed into a window casing, the spring-loaded mounting brackets are released to provide a compression fit between the window covering and the window casing. Unfortunately, in some cases, such springs may generate insufficient force to secure the window covering to the window casing, particularly with long or heavy window coverings. This can result in movement or creep of the window covering relative to the window casing.

### SUMMARY

Embodiments of the present disclosure are directed to an extensible mounting assembly for a window covering including a headrail, a carriage within the headrail at an end of the headrail, and a movable portion positioned in the carriage and configured to move relative to the carriage between a retracted position and an extended position. The assembly also includes a cam that rotates on the carriage and contacts the movable portion. Rotation of the cam relative to the movable portion causes the movable portion to move between the extended position and the retracted position. The assembly further includes a flange extending from the cam to maintain the cam in the carriage by holding the cam in place relative to the movable portion. The assembly also includes a lever extending from the cam that is fixed to the cam. Rotation of the lever and cam together causes the movable portion to extend and press against the window casing to secure the headrail to the window casing. The assembly also includes a biasing member between the cam and the movable portion and configured to maintain the cam and movable portion in contact as the lever and cam rotate and to maintain the flange in place relative to the movable portion.

Further embodiments of the present disclosure are directed to a window covering including a headrail spanning a window casing, and an end cap assembly in an end of the headrail. The end cap assembly includes a carriage, a movable portion extensible from a retracted position in the carriage to an extended position protruding at least partially from the carriage, and a mounting bracket coupled to the movable portion and being configured to forcibly contact the window casing and secure the headrail in the window casing. The window covering also includes a cam contacting the movable portion and being configured to move the movable portion from the retracted position to the extended position, and a flange extending from the cam and contacting the movable portion. The flange maintains the movable portion in position relative to the carriage. The window covering further includes a lever coupled to the cam. Rotation of the lever causes the cam to move the movable portion.

Still further embodiments of the present disclosure are directed to a method including providing a headrail having a first end and a second end that are configured to span a window casing, and providing an end cap assembly in the first end that is configured to extend upon rotating a lever that turns a cam that urges the first end to compress the headrail in the window casing. The cam comprises a cam surface configured to contact the movable portion and a flange configured to impede movement of the cam along its axis transverse to the headrail.

Further aspects and embodiments are provided in the foregoing drawings, detailed description and claims.

### BRIEF DESCRIPTION OF THE DRAWINGS

The following drawings are provided to illustrate certain embodiments described herein. The drawings are merely illustrative and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1 is a perspective view showing embodiments of a window covering installed using an extensible end cap assembly in accordance with embodiments of the present disclosure.

FIG. 2 shows the window covering removed from the window casing, with the extensible end cap assembly installed in an end thereof according to embodiments of the present disclosure.

FIGS. 3A and 3B show an embodiment of an extensible end cap assembly in a retracted position (FIG. 3A) and in an extended position (FIG. 3B).

FIG. 4 is a top view of the extensible end cap assembly with a top cover removed to more clearly depict features of the assembly according to further embodiments of the present disclosure.

FIG. 5 is an isometric view of the lever arm and cam according to embodiments of the present disclosure.

FIG. 6 is an exploded view of the assembly according to embodiments of the present disclosure.

FIG. 7 is a side view of a cam, cam block, and flange according to embodiments of the present disclosure.

FIG. 8 is a side view of a cam, cam block, and flange according to embodiments of the present disclosure.

FIG. 9 is a side view of a sloped cam, sloped cam block, and flange according to embodiments of the present disclosure.

FIG. 10 is a side view of a cam, cam block, and flange according to further embodiments of the present disclosure.

### DETAILED DESCRIPTION

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

### Definitions

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

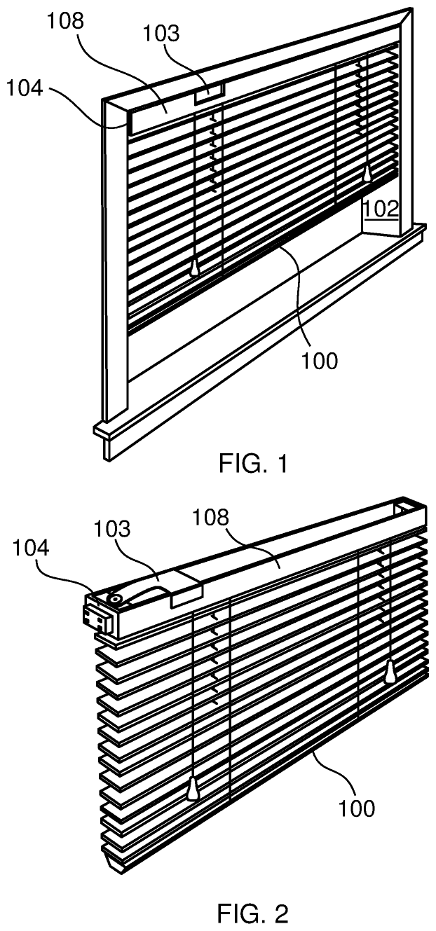

FIG. 1 is a perspective view showing embodiments of a window covering 100 installed using an extensible end cap assembly 104 in accordance with embodiments of the present disclosure. As shown, the extensible end cap assembly 104 is coupled to an end of a headrail 108 of the window covering 100. The extensible end cap assembly 104 is configured to retain the window covering 100 within a window casing 102 by creating a compression fit between the headrail 108 and the window casing 102. That is, the extensible end cap assembly 104 is configured to extend relative to an end of the headrail 108 to create compression against the inside of the window casing 102, thereby retaining the window covering 100 within the window casing 102. The lever 103 may be used to extend and retract a piston portion of end cap assembly in order to create a compression fit between headrail 108 and window casing 102.

FIG. 2 shows the window covering 100 removed from the window casing 102, with the extensible end cap assembly 104 installed in an end thereof according to embodiments of the present disclosure. As shown, the extensible end cap assembly 104 may, in certain embodiments, slide into an end of the headrail 108. In other embodiments, the extensible end cap assembly 104 slides over the end of the headrail 108, such as in cases where the end of the headrail 108 is closed. The extensible end cap assembly 104 may be sized to fit snugly within the headrail 108. The extensible end cap assembly 104 may also be provided in different sizes to accommodate headrails 108 of different dimensions. In other embodiments, the extensible end cap assembly 104 may include different adapters to fit different sizes of headrails 108, thereby allowing a uniform-size extensible end cap assembly 104 to be installed in different size headrails 108. The lever arm 103 may be used to extend and retract a piston portion of end cap assembly in order to create a compression fit between headrail 108 and window casing 102.

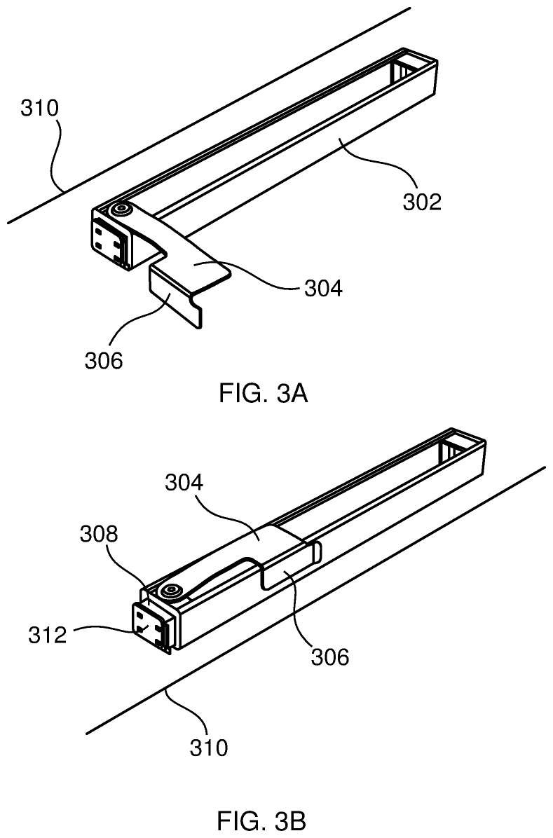

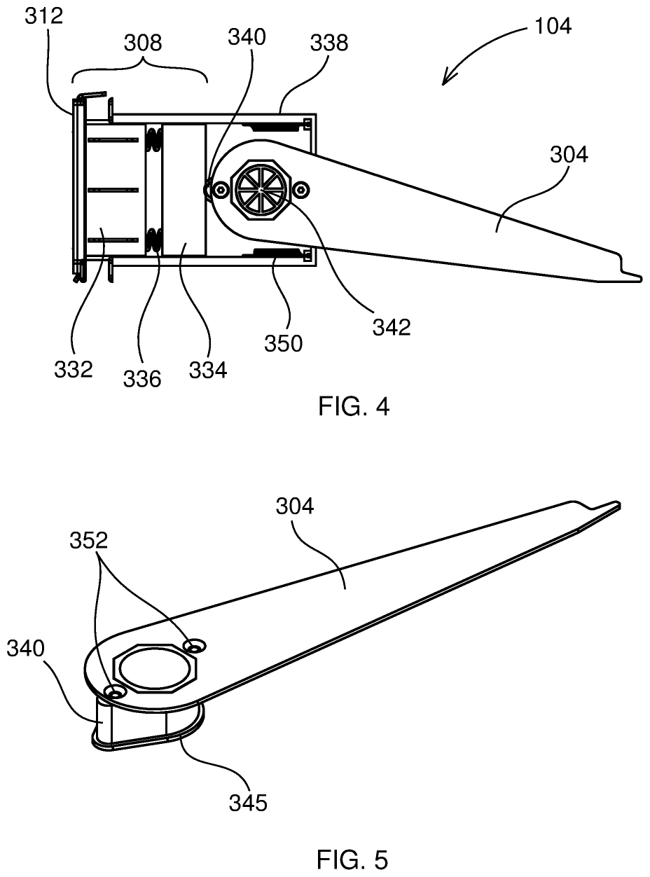

FIGS. 3A and 3B show an embodiment of an extensible end cap assembly 104 in a retracted position (FIG. 3A) and in an extended position (FIG. 3B). FIG. 3A depicts a lever arm 304 which is in a substantially perpendicular position compared to a headrail 302 and to a horizontal headrail axis 310. FIG. 3B depicts a lever arm 304 which is in a substantially parallel position compared to a headrail 302 and to a horizontal headrail axis 310. When lever arm 304 is in its parallel position end cap assembly is in an extended position as shown in FIG. 3B. In FIG. 3B we can clearly see a movable portion 308 which is like a piston. When lever arm 304 is rotated a cam 340 (shown in FIGS. 4-6) rotates and moves movable portion 308 creating a compression fit between the headrail 108 and the window casing 102.

FIG. 4 is a top view of the extensible end cap assembly 104 with a top cover removed to more clearly depict features of the assembly 104 according to further embodiments of the present disclosure. The assembly 104 includes a carriage 338 configured to fit within the head rail shown in FIGS. 1-3B. The assembly 104 also includes a movable portion 308 that itself consists of an end cap assembly 332, a cam block 334, and a biasing element 336 between the end cap assembly 332 and the cam block 334. The movable portion 308 fits within the carriage 338 and is allowed to move along the headrail axis 310 (shown to greater advantage in FIGS. 3A and 3B). The biasing element 336 can be a spring or a pair of springs or any other suitable flexible element. The flexibility afforded by the movable portion 308 allows the assembly 104 to fit within a wide variety of window casings and to account for inaccuracies and deformations in manufacture of both the assembly 104 itself and the window into which the assembly 104 is placed. In other embodiments the movable portion 308 is a single block of flexible material that allows sufficient flexibility without using a two-piece design. In still other embodiments, the movable portion 308 could include an additional cam block with an additional biasing element. The assembly 104 also includes a mounting bracket 312 at a distal end of the assembly 104 and mounted to the movable portion 308 such that movement of the movable portion 308 causes the mounting bracket 312 to extend outwardly and contact a window casing to secure the assembly 104 in the window casing. The mounting bracket 312 can include projections and/or an adhesive to hold the assembly 104 and the headrail in place in the window.

The movable portion 308 can be keyed to the carriage 338 to allow horizontal movement, but to impede vertical movement, where vertical movement in FIG. 4 would be movement upward out of the viewing plane toward the viewer. In some embodiments the keying can be achieved by means of a groove in the sidewalls of the carriage 338. The groove can prevent movement upward and downward in the carriage 338. In other embodiments the carriage 338 has no groove, and instead maintains the movable portion 308 within the carriage 338 with a cap that is not shown in FIG. 4 but that covers the movable portion 308 throughout the travel of the movable portion 308 as the lever 304 is actuated. The carriage 338 includes a journal 342 that protrudes upward and has a circular outer surface configured to receive the cam 340 which is coupled to the lever arm 304.

FIG. 5 is an isometric view of the lever arm 304 and cam 340 according to embodiments of the present disclosure. The lever arm 304 includes a cam 340 that protrudes generally opposite the lever arm 304 and is configured to move the movable portion 308 along the carriage 338 as the lever arm 304 is actuated. The lever arm 304 is shown in FIG. 4 in the closed position in which the lever arm 304 is retracted against the headrail 302 (shown in FIGS. 3A and 3B) and the cam 340 contacts the cam block 334 to extend the movable portion 308. The assembly 104 includes biasing members 350 that urge the movable portion 308 toward the cam 340 to maintain contact with the cam 340 and the cam block 334 to ensure smooth operation of the assembly 104. The lever arm 304 is secured to the cam 340 via screws 352 and an octagonal shape of an outer surface of the cam 340 and an interior surface of the lever arm 304 helps the lever arm 304 transmit torque to the cam 340 which rotates along the journal 342. In some embodiments the moment arm created between the lever arm 304 and the cam 340 is approximately as wide as the carriage 338.

The lever arm 304 can be relatively thin when compared to the cam 340. The interior portion of the cam 340 can be circular and configured to facilitate rotation about the journal 342 (shown in FIG. 4). The cam 340 is shown with an octagonal shape and the lever arm 304 has a corresponding shape to transmit torque from the lever arm 304 to the cam 340. It is to be appreciated that other shapes can be used without departing from the scope of the present disclosure, including square, hexagonal, pentagonal, triangle, linear, etc. or any other suitable shape. Furthermore, the lever arm 304 is secured to the cam 340 via screws 352. In some embodiments the screws are sufficient to transmit the necessary torque and the shape of the lever arm 304 can be circular or another non-torque transmitting shape. The lever arm 304 can also have a more ergonomic handle 306 such as that shown in FIGS. 1-3B.

The cam 340 includes a flange 345 that extends outwardly from the cam surface at a lower end of the cam 340. The flange 345 extends underneath the cam block 334 and prevents movement of the cam 340 and lever arm 304 relative to the assembly 104 in a vertical direction. The biasing members 350 ensure that the flange 345 is engaged with the cam block 334 at all positions of the lever arm 304 so that the cam 340 and lever arm 304 are maintained in the assembly 104 without the need for additional fasteners. The flange 345 also prevents the cam 340 from binding up by ensuring orthogonal movement of the cam 340 relative to the cam block 334.

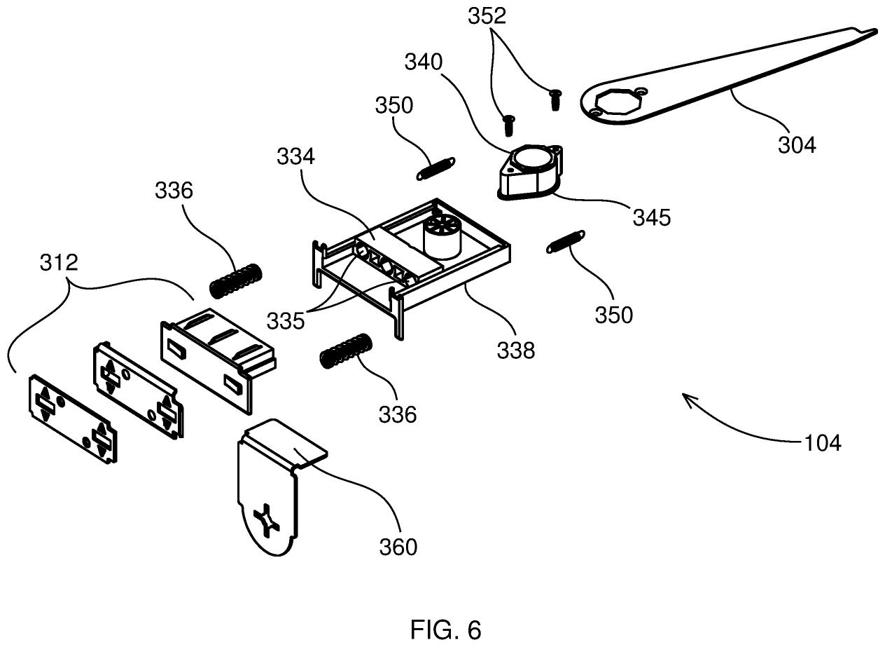

FIG. 6 is an exploded view of the assembly 104 according to embodiments of the present disclosure. The journal 342 is shown here to greater advantage as a cylindrical protrusion extending upward from the carriage 338 and configured to engage with the cam 340 to allow rotation of the cam 340 relative to the carriage 338. The torque-transmitting shape of the lever arm 304 and correspondingly on the cam 340 is also shown here. The cam block 334 can include holes 335 that receive the biasing elements 336. The assembly 104 also includes a bracket 360 that is coupled to the carriage 338. The bracket 360 extends downwardly and holds a roller or other component of the window covering that is to be secured by the assembly 104 according to embodiments of the present disclosure.

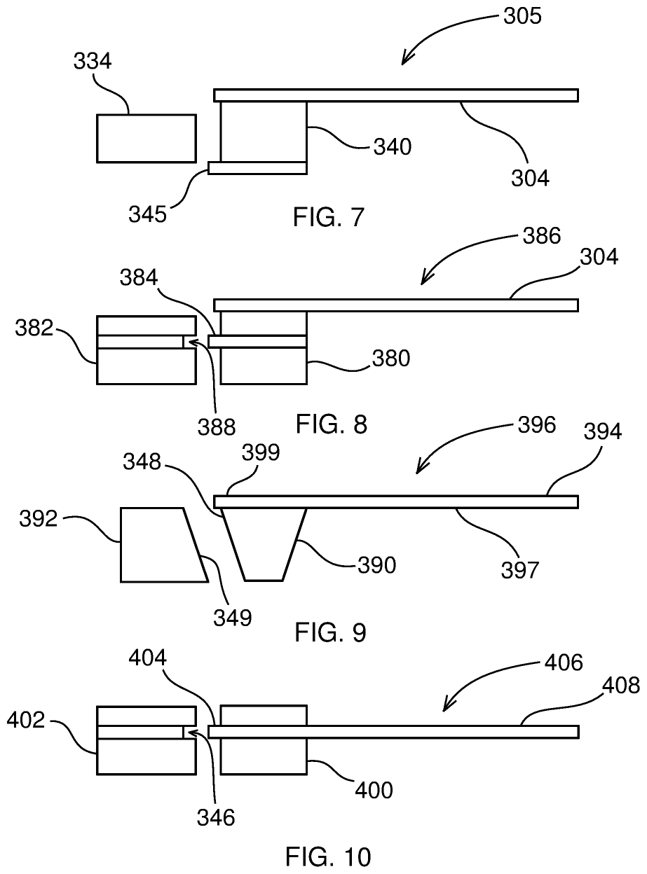

FIG. 7 is a side view of a cam 340, cam block 334, and flange 345 according to embodiments of the present disclosure. The cam block 334 is positioned relative to a lever assembly 305 which itself includes a lever arm 304, the cam 340, and the flange 345. The flange 345 extends underneath a portion of the cam block 334 to prevent vertical motion of the lever assembly 305. The flange 345 accordingly prevents upward movement of the lever assembly 305 which is therefore maintained in place relative to the cam block 334 as the assembly is operated to install the window covering in the window. The flange 345 can extend around a periphery of the cam 340 sufficiently to remain underneath the cam block 334 throughout the entire range of motion of the lever 304.

FIG. 8 is a side view of a cam 380, cam block 382, and flange 384 according to embodiments of the present disclosure. There is also a lever assembly 386 used to actuate the cam to secure the window covering in the window. In this embodiment the flange 384 is at an intermediate position on the cam 380, and the cam block 382 has a correspondingly positioned groove 388 configured to receive the flange 384 to prevent vertical movement of the lever assembly 386 relative to the cam block 380.

FIG. 9 is a side view of a sloped cam 390, sloped cam block 392, and flange 394 according to embodiments of the present disclosure. The sloped cam 390 and flange 394 together form the lever assembly 396. The lever 394 is the flange in this embodiment, with a handle portion 397 extending to the right, and a flange portion 399 at the left outward and over a portion of the cam block 392. The sloped cam 390 has a sloped profile 348 with the upper portion being larger than the bottom portion, and an opposing slope 349 on the cam block 392. This embodiment also prevents vertical movement of the lever assembly 396 relative to the cam block 392.

FIG. 10 is a side view of a cam 400, cam block 402, and flange 404 according to further embodiments of the present disclosure. The lever assembly 406 includes the cam 400 and the lever 408. A portion of the lever 408 extends to the left and serves as the flange 404. The cam block 402 can have a groove 346 configured to receive the flange 404, which in this embodiment is a unitary member with the lever 408. The vertical position of the lever 408 can vary as desired. Accordingly, the lever assembly 406 is maintained in proper position relative to the overall assembly.

The foregoing disclosure hereby enables a person of ordinary skill in the art to make and use the disclosed systems without undue experimentation. Certain examples are given to for purposes of explanation and are not given in a limiting manner. All patents and published patent applications referred to herein are incorporated herein by reference.

1. An extensible mounting assembly for a window covering, comprising:
a headrail;
a carriage within the headrail at an end of the headrail;
a movable portion positioned in the carriage and configured to move relative to the carriage between a retracted position and an extended position;
a cam rotatably coupled to the carriage and configured to contact the movable portion, wherein rotation of the cam relative to the movable portion causes the movable portion to move between the extended position and the retracted position;
a flange extending from the cam and configured to maintain the cam in the carriage by holding the cam in place relative to the movable portion;
a lever extending from the cam and being fixed to the cam, wherein rotation of the lever and cam together causes the movable portion to extend and press against a window casing to secure the headrail to the window casing; and
a biasing member between the cam and the movable portion and configured to maintain the cam and movable portion in contact as the lever and cam rotate and to maintain the flange in place relative to the movable portion.

2. The extensible mounting assembly of claim 1, further comprising an adhesive surface on the movable portion to secure the headrail to the window casing.

3. The extensible mounting assembly of claim 1, further comprising barbs protruding from the movable portion to secure the headrail to the window casing.

4. The extensible mounting assembly of claim 1 wherein the flange extends from a bottom portion of the cam extends underneath the movable portion.

5. The extensible mounting assembly of claim 1 wherein the flange prevents movement in a vertical direction relative to the carriage.

6. The extensible mounting assembly of claim 1 wherein the movable portion has a groove configured to receive the flange.

7. The extensible mounting assembly of claim 1 wherein the cam has a sloped profile that is wider at an upper region and narrower at a lower region and wherein the movable portion has a corresponding, oppositely sloped profile such that the cam prevents the movable portion from moving in a vertical direction relative to the carriage.

8. The extensible mounting assembly of claim 1 wherein the flange is part of the lever.

9. A window covering, comprising:
a headrail spanning a window casing;
an end cap assembly in an end of the headrail, the end cap assembly comprising:
a carriage;
a movable portion extensible from a retracted position in the carriage to an extended position protruding at least partially from the carriage;
a mounting bracket coupled to the movable portion and being configured to forcibly contact the window casing and secure the headrail in the window casing;
a cam contacting the movable portion and being configured to move the movable portion from the retracted position to the extended position;
a flange extending from the cam and contacting the movable portion, the flange being configured to maintain the movable portion in position relative to the carriage; and
a lever coupled to the cam, wherein rotation of the lever causes the cam to move the movable portion.

10. The window covering of claim 8 wherein the movable portion comprises a flexible member configured to compress when the movable portion is moved from the retracted position to the extended position.

11. The window covering of claim 8, further comprising a biasing member urging the cam into contact with the movable portion.

12. The window covering of claim 8 wherein the lever is generally flush with the headrail when the movable portion is in the extended position.

13. The window covering of claim 8 wherein the carriage has a groove and the movable portion is configured to move within the groove between the retracted position and the extended position.

14. The window covering of claim 8 wherein the carriage comprises a journal with an axis of rotation transverse to the headrail and wherein the cam is configured to rotate about the journal, and wherein a diameter of the journal is at least one third as long as the carriage is wide.

15. The window covering of claim 8 wherein the cam has a torque-transmitting profile and the lever has a corresponding profile that is coupled to the cam, wherein the torque-transmitting profile permits the lever to transmit torque to the cam.

16. The window covering of claim 15 wherein the torque-transmitting profile comprises an octagon.

17. A method, comprising:
providing a headrail having a first end and a second end that are configured to span a window casing;
providing an end cap assembly in the first end that is configured to extend upon rotating a lever that turns a cam that urges the first end to compress the headrail in the window casing, wherein the cam comprises a cam surface configured to contact the movable portion and a flange configured to impede movement of the cam along its axis transverse to the headrail.

18. The method of claim 17, further comprising providing a roller assembly coupled to the headrail.

19. The method of claim 17, further comprising providing a biasing member configured to urge the cam against the movable portion such that the flange remains in contact with the movable portion throughout the rotation of the cam.

20. The method of claim 17 wherein the flange is part of the lever.
